(19) United States
(12) Patent Application Publication
(10) Pub. No.: US 2016/0144440 A1
(43) Pub. Date: May 26, 2016

(54) Welding Method for the Shielding of Hardened Wearing Elements in Hoppers, Buckets or Other Similar Equipment

(71) Applicant: Minetec S.A., Santiago (CL)

(72) Inventors: Claudio ZAMORANO JONES, Santiago (CL); Bernardo VERA TORRES, Santiago (CL)

(21) Appl. No.: 14/571,970

(22) Filed: Dec. 16, 2014

(30) Foreign Application Priority Data
Nov. 21, 2014 (CL) 3166-2014

(51) Int. Cl. B23K 9/025; B23K 9/18; B23K 9/028; B23K 9/16

(52) U.S. Cl. CPC B23K 9/0256; B23K 9/16; B23K 9/18; B23K 9/028

(57) ABSTRACT

The invention consists in a welding method for hardened wearing elements such as straps, retaining walls, blocks and various forms of shielding plates used in hoppers, ladles and any component that needs to be protected with hardened wearing elements, which prevents stress in the binding welded between the straps and allows joining straps with very little spacing between them so that no wearing grooves are formed. The method comprises placing two straps separated by a minimum space on the base plate to be welded; separating the straps to be welded allowing a minimum of 0.5 to 5 mm; welding with a welding bead; using discontinuous welding beads; applying the welding bead on the side edges of the straps and discontinuing the welding bead in areas close to the space between two straps.

### CROSS-REFERENCE TO RELATED APPLICATIONS

This application claims the benefit of co-pending Chilean Patent Application No. CL 3166-2014, filed 21 Nov. 2014, which is hereby incorporated herein.

### TECHNICAL FIELD

The invention is related to the field of shields for earthmoving elements subject to wear, specifically the invention relates to a method of welding for hardened wearing elements, such as straps, retaining walls, blocks and various forms of shielding plates.

### DESCRIPTION OF THE PRIOR ART

At present, mounting of hardened material shields (anti-abrasive steel) is used for coating earthmoving elements, such as truck hoppers, crane buckets, excavator shovels and others, this material may be mounted using fastening or welding elements to such elements as shielding parts of varying size and shape.

The closest document is application WO 2013059334, which discloses the use of hardened metal straps for shielding a truck hopper, the use of straps located transversely or diagonally to the axis of the hopper and also pieces of hardened material located at the corner points of the loading box is observed in this material, such hardened material straps or pieces are mounted to the hopper floor by welding.

There are also other documents in the prior art, such as US2004002659, which also show resistant plates or straps welded to a truck hopper's body floor.

Furthermore, also in the prior art, there are companies selling various coatings for mechanical elements, which are welded, as in the case of the DOMITE company website http://www.domite.com/html/chocky-bars.html, which sells hardened material “sachet” bars for installation in earthmoving elements subject to wear, or RAPTOR company http://www.raptorwearparts.com/product.php?id=28.

None of the solutions disclosed above mentions the disruption of the weld bead at the junction of the hardened shielding material elements, as is the purpose of the present invention.

### SUMMARY OF THE INVENTION

The invention discloses a method of welding which covers only the lateral sides of the straps and not their ends which are adjacent to the next strap. The weld beads of the lateral sides have their start and end before the discontinuities. This method prevents cracks during work and allows stress relief in the area of separation between the straps.

### BRIEF DESCRIPTION OF THE FIGURES

FIG. 1a shows a front view of the weld to the base plate for two guarding elements separated from each other and surrounded by the weld bead representing the prior art.

FIG. 1b shows a top view of the weld to the base plate for two guarding elements separated from each other and surrounded by the weld bead representing the prior art.

FIG. 2a shows a front view of the weld to the base plate for two guarding elements close to each other and joined together by a continuous weld bead representing the prior art.

FIG. 2b shows a top view of the weld to the base plate for two guarding elements close to each other and joined together by a continuous weld bead representing the prior art.

FIG. 3a shows a front view of the weld to the base plate for one longer guarding element joined via a continuous weld bead.

FIG. 3b shows a top view of the weld to the base plate for a longer guarding element joined via a continuous weld bead.

FIG. 4a shows a front view of the weld to the base plate for two guarding elements close to each other and joined together by a discontinuous weld bead.

FIG. 4b shows a top view of the weld to the base plate for two guarding elements close to each other and joined together by a discontinuous weld bead.

FIG. 5 shows an isometric view which depicts two guarding elements that are welded discontinuously to an intermediate material between these elements and the base plate.

FIG. 6 shows an isometric view of how wearing elements are joined by a discontinuous welding, such as that of the invention, which considers an intermediate material on curved surfaces.

### DETAILED DESCRIPTION OF THE INVENTION

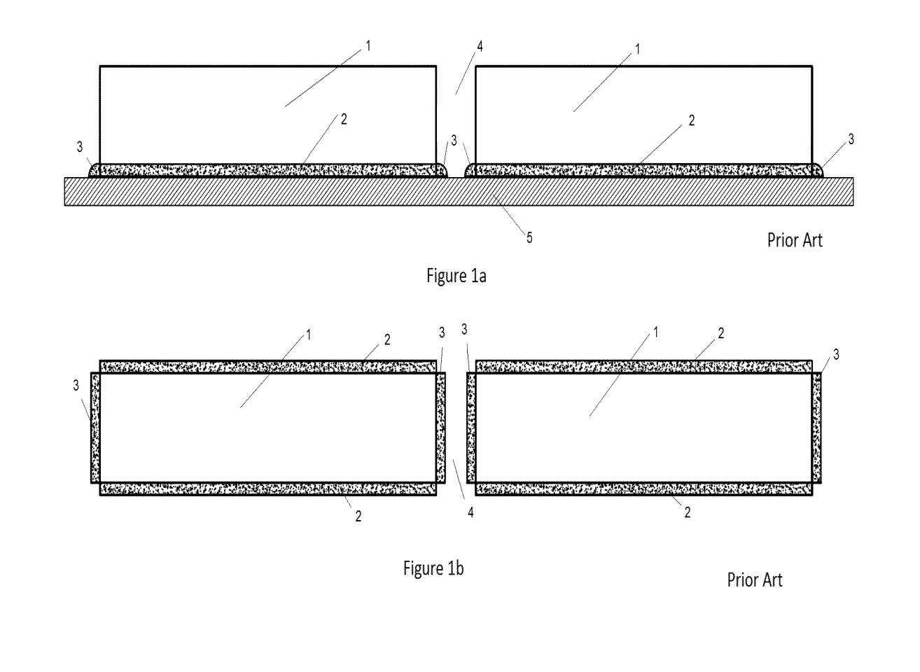

A method of joining straps (1) to a base plate (5) which is commonly used in the State of the Art may be that shown in FIGS. 1a and 1b, where two adjacent straps (1) are welded to the base plate (5), for example, in a hopper, bucket or shovel with continuous weld beads (2.3) on all sides to prevent the material from entering under the strap (1) making it finally separate from the base plate (5), furthermore, the space (4) between the two straps, and which is necessary to create the weld bead (3) between the two straps, allows the hopper or bucket, when emptying, to slide material between said spaces (4), causing wearing of the base plate (5).

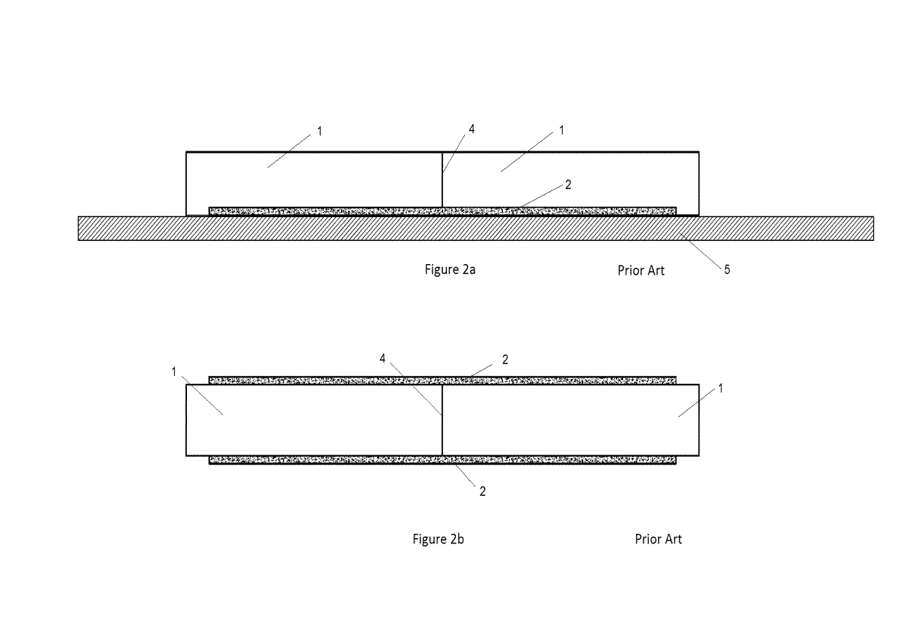

Another method of joining straps (1) to the base plate (5) which is also commonly used in the State of the Art may be that shown FIGS. 2a and 2b, where two adjacent straps (1) are welded to the base plate (5), for example, in a hopper or bucket with continuous weld beads on lateral sides, by a single continuous weld bead (2) on each side, since in this case the two straps (1) are very slightly apart and the space (4) between them is minimum, in this case no material is deposited between the two straps (1) in the space (4), but there are stresses in the continuous weld bead (2) just below the space (4) separating one strap (1) from the other, since it does not allow for flexibility of the floor or base plate (5) with respect to each of the straps (1) individually, leading to sliding of the straps and/or cracking in the weld bead with use.

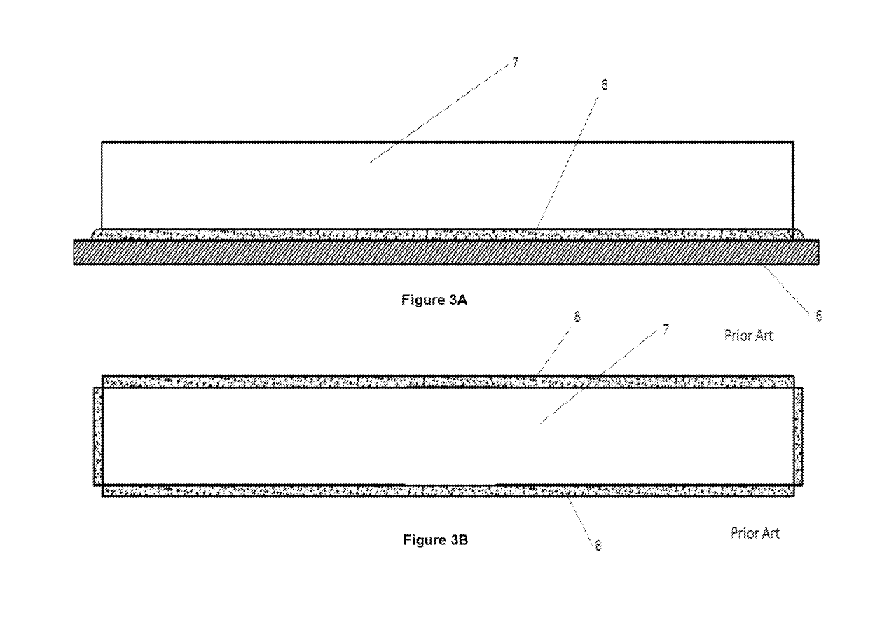

A third method for joining straps (1) to a base plate (5) which is also commonly used in the State of the Art may be that shown in FIGS. 3a and 3b, where a longer strap (7) is welded to the base plate (5) by a continuous weld bead. In this case, being a single strap, no disruption of the bead is required, the disadvantage is that, being a single larger and non-joining strap, stresses are transmitted to this strap and may lead to cracks and crevices, since anti-abrasive steels are not intended for structural use. The complication is even bigger in this method when the base plate is curved, since it involves bending the strap, causing additional internal stresses.

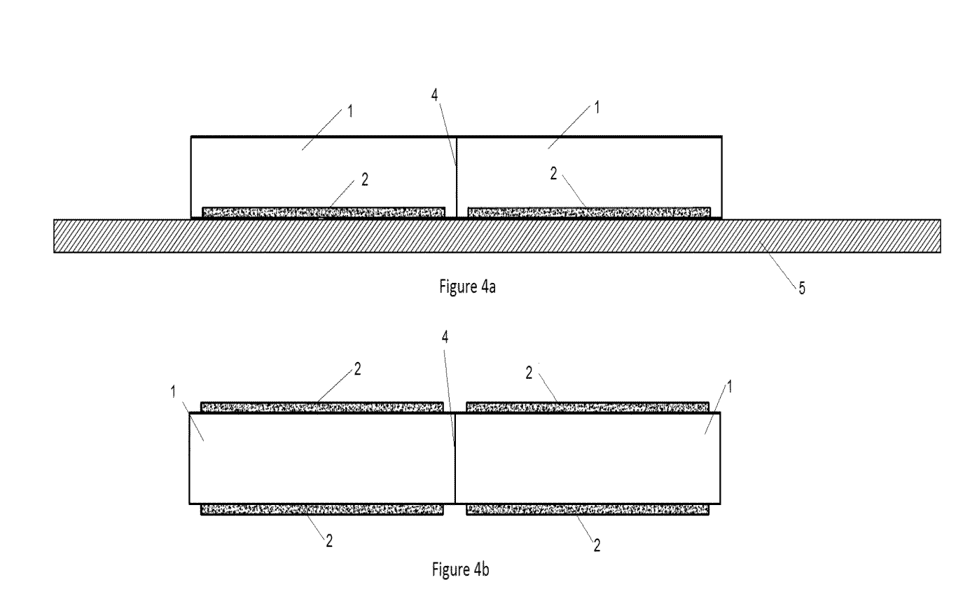

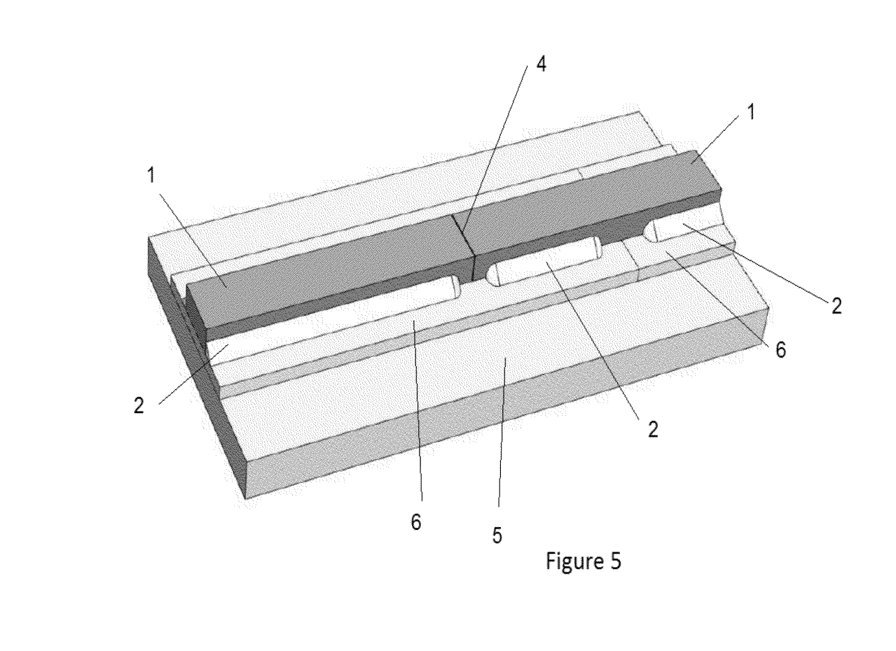

The proposed solution and the purpose of the invention are depicted in FIGS. 4a, 4b and 5 where it can be seen that two straps (1) are separated by a minimum space (4), the weld bead (2) is applied to the lateral sides of said straps (1), thus disrupting the weld bead (2) just before reaching the separation space (4) of both straps (1) to continue welding a little beyond that space on the next strap (1). Therefore, the accumulation of material in the space (4) between both straps (1) is prevented, and stresses in the weld bead in the area of separation (4) of both straps (1) are also avoided. The method is also applied to straps (1) that consider an intermediate material (6) between the base plate (5) and the straps (1), as is the case of shielding straps with retaining walls or a bi-layer shielding, as shown in FIG. 5.

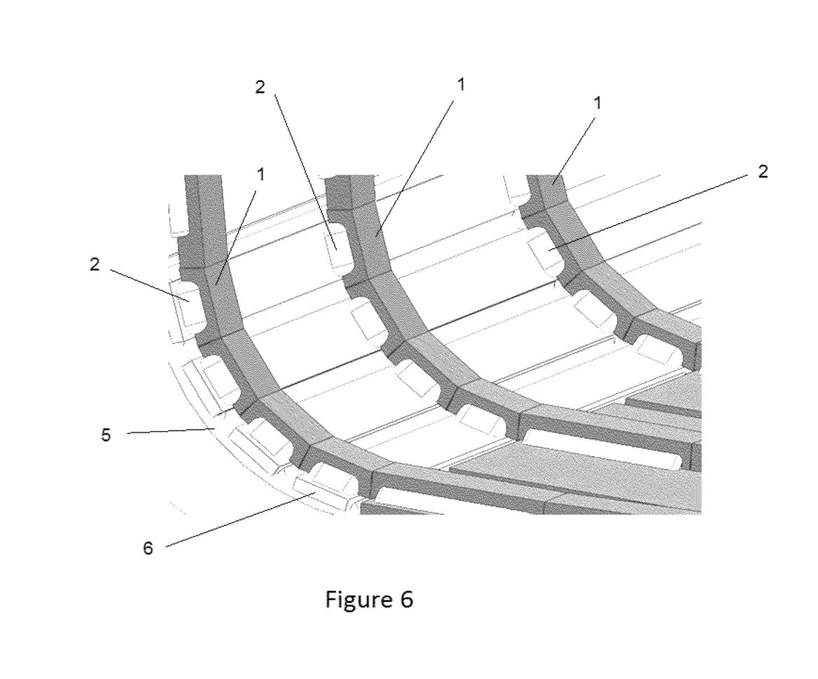

The method of welding may also be applied to curved surfaces, such as a base plate (5), as shown in FIG. 6, in which an intermediate material (6) is used, upon which the wearing elements that may be straps are welded (1).

The welding for this method may be done using MIG system, TIG, manual arc, submerged arc or any other arc welding process and filler material.

What is claimed is:

1. A method of welding for hardened wearing elements, such as straps, retaining walls, blocks and various forms of shielding plates, used in hoppers, buckets or any component that needs to be guarded by hardened wearing elements that prevents stresses in the joint welded between the straps, and allows joining straps with little separation between them, so that no wearing grooves are formed, comprising:
placing two straps separated by a minimum space on the base plate to be welded;
separating the straps to be welded allowing a minimum space of 0.5 to 5 mm welding with a weld bead;
using discontinuous weld beads;
apply the weld bead at the lateral sides of the straps; and
discontinuing the weld bead in areas close to the space between two straps.

2. A welding method according to claim 1, wherein it may be applied on curved surfaces.

3. A welding method according to claim 1, wherein it may be done with MIG system, TIG, manual arc, submerged arc or any other arc welding process and filler material.

4. A method for welding according to claim 1, wherein it may be applied when straps consider an intermediate material between the base plate and said strap.
